(19) United States
(12) Patent Application Publication
(10) Pub. No.: US 2025/0249497 A1
(43) Pub. Date: Aug. 7, 2025

(54) METHOD OF MANUFACTURING FLOOR MEMBER

(71) Applicant: FUTABA INDUSTRIAL CO., LTD., Okazaki-shi (JP)

(72) Inventor: Kenji Niwa, Okazaki-shi (JP)

(21) Appl. No.: 19/039,137

(22) Filed: Jan. 28, 2025

(30) Foreign Application Priority Data
Feb. 5, 2024 (JP) 2024-015915

(51) Int. Cl. B21D 39/02; B21D 53/88; B62D 25/20; B62D 27/02

(52) U.S. Cl. CPC B21D 39/021; B21D 53/88; B62D 25/20; B62D 27/023

(57) ABSTRACT

A method of manufacturing a floor member of a vehicle includes: forming beads in respective bead parts in a body member; arranging two or more reinforcing members in respective two or more covered parts in the body member; welding the body member and the two or more reinforcing members, to thereby form a joined member; and performing cold press forming on the joined member. One or more lower ridgeline parts are formed by the cold press forming so as to correspond to each of the two or more reinforcing members. Each lower ridgeline part extends along a ridgeline. The lower ridgeline part is bent so as to protrude towards the body member in a cross-section orthogonal to the ridgeline. Each bead part is located at or near a corresponding one lower ridgeline part of the one or more lower ridgeline parts.

### CROSS-REFERENCE TO RELATED APPLICATIONS

The present application claims the benefit of Japanese Patent Application No. 2024-015915 filed on Feb. 5, 2024 with the Japan Patent Office, the disclosure of which is incorporated herein in its entirety by reference.

### BACKGROUND

The present disclosure relates to a method of manufacturing a floor member.

As disclosed in Japanese Unexamined Patent Application Publication No. 2020-199520, there has been known a technique of manufacturing a press-formed product by: forming an overlapped blank from a main steel plate and a reinforcing steel plate that are placed in an overlapping manner by joining them by spot welding; and performing press forming on the overlapped blank.

### SUMMARY

In the press-formed product manufactured by the technique of Japanese Unexamined Patent Application Publication No. 2020-199520, however, the reinforcing steel plate is arranged in contact with an inner peripheral surface of the main steel plate, at its bent parts. Thus, when the press forming is performed on the overlapped blank, there is a possibility where a shear force is generated in a joined part between the main steel plate and the reinforcing steel plate, leading to breakage of the joined part.

In one aspect of the present disclosure, it is desirable to inhibit the breakage of the joined part.

One aspect of the present disclosure provides a method of manufacturing a floor member included in a floor of a vehicle. The method comprises: forming beads in respective two or more bead parts in a body member in a form of a plate; and arranging two or more reinforcing members so as to cover respective upper surfaces of two or more covered parts in the body member. The beads are bent so as to protrude from a lower surface of the body member. The two or more reinforcing members are in a form of plates thicker than the body member. Moreover, the method comprises: welding the body member and the two or more reinforcing members that are arranged in the respective two or more covered parts, to thereby form a joined member; and performing cold press forming on the joined member, to thereby form the floor member. One or more lower ridgeline parts are formed by the cold press forming so as to correspond to each of the two or more reinforcing members. Each lower ridgeline part of the one or more lower ridgeline parts extend along a ridgeline. The each lower ridgeline part includes a portion of a corresponding one reinforcing member and a portion of a corresponding one covered part of the two or more covered parts that is covered with the corresponding one reinforcing member. The each lower ridgeline part is bent so as to protrude towards the body member in a cross-section orthogonal to the ridgeline. The each lower ridgeline part corresponds to a corresponding one bead part of the two or more bead parts. Each bead part of the two or more bead parts is located at or near a corresponding one lower ridgeline part of the one or more lower ridgeline parts.

According to the above configuration, when the cold press forming is performed on the joined member, stretching occurring in the body member around its one or more lower ridgeline parts can be absorbed with the bead part(s). Therefore, breakage can be inhibited in joined parts between the body member and the two or more reinforcing members.

In one aspect of the present disclosure, at least one reinforcing member of the two or more reinforcing members may be arranged so as to extend beyond the body member.

According to such a configuration, another member can be reinforced with the at least one reinforcing member extending beyond the body member.

In one aspect of the present disclosure, at least one bead part of the two or more bead parts may be provided so as to cross a corresponding one covered part of the two or more covered parts.

According to such a configuration, when the cold press forming is performed on the joined member, the stretching occurring in the body member around its one or more lower ridgeline parts can be more favorably absorbed with the bead part(s). Therefore, the breakage can be more favorably inhibited in the joined parts between the body member and the two or more reinforcing members.

In one aspect of the present disclosure, in the floor member, a gap may be formed between at least one bead part of the two or more bead parts in the body member and a reinforcing member of the two or more reinforcing members. The reinforcing member is provided with a lower ridgeline part of the one or more lower ridgeline parts corresponding to the at least one bead part.

Such a configuration can improve stiffness of the floor member around the bead part(s).

In one aspect of the present disclosure, each covered part of the two or more covered parts may be provided adjacent to an end of the body member.

Such a configuration can inhibit the breakage of the joined parts between the body member and the two or more reinforcing members.

In one aspect of the present disclosure, the body member may have a substantially rectangular shape extending in a longitudinal direction. Furthermore, the each covered part may be provided adjacent to the end of the body member extending in the longitudinal direction.

Such configurations can inhibit the breakage of the joined parts between the body member and the two or more reinforcing members.

In one aspect of the present disclosure, the floor member may include at least one protrusion protruding towards the two or more reinforcing members. The one or more lower ridgeline parts corresponding to each of the two or more reinforcing members may be provided along an edge of the at least one protrusion.

Such a configuration can inhibit the breakage of the joined parts between the body member and the two or more reinforcing members around the edge of the at least one protrusion.

In one aspect of the present disclosure, the at least one protrusion may include two or more protrusions. The body member may have a substantially rectangular shape extending in a longitudinal direction. The two or more protrusions may be arranged in an aligned manner along the longitudinal direction.

Such a configuration can inhibit the breakage of joined parts between the body member and the two or more reinforcing members around edges of the two or more protrusions.

In one aspect of the present disclosure, the two or more bead parts may extend along a width direction orthogonal to the longitudinal direction.

Such a configuration can inhibit the breakage of the joined parts between the body member and the two or more reinforcing members around the edges of the two or more protrusions.

In one aspect of the present disclosure, the cold press forming performed on the joined member may be carried out by pressing the joined member with a lower die from the lower surface of the body member. A surface of the lower die to press the lower surface of the body member may be provided with two or more recesses configured to arrange therein the respective two or more bead parts.

Such a configuration can inhibit squashing of the beads formed in the respective bead parts in performing the cold press forming on the joined member.

### BRIEF DESCRIPTION OF THE DRAWINGS

Example embodiments of the present disclosure will be described hereinafter with reference to the accompanying drawings, in which:

FIG. 1 is a perspective view of a floor member;

FIG. 2 is an explanatory diagram of a body member, an upper die, and a lower die in a bead forming process, as viewed from a longitudinal end of the body member;

FIG. 3 is an explanatory diagram of an upper surface of the body member in which a bead is formed;

FIG. 4 is an explanatory diagram of a joined member formed in a joining process, as viewed from the longitudinal end of the body member;

FIG. 5 is an explanatory diagram showing, at a part of the joined member provided with a reinforcing member, a cross-sectional view orthogonal to width directions and the upper die and the lower die in a pressing process;

FIG. 6 is an explanatory diagram of a part, provided with the reinforcing member, of the joined member in the course of cold press forming during the pressing process, showing a cross-sectional view orthogonal to the width directions, and the upper die and the lower die in the pressing process;

FIG. 7 is a cross-sectional view of a lower ridgeline part orthogonal to a ridgeline; and

FIG. 8 is a cross-sectional view of the lower ridgeline part orthogonal to the ridgeline.

### DETAILED DESCRIPTION OF EXEMPLARY EMBODIMENTS

### 1. Floor Member

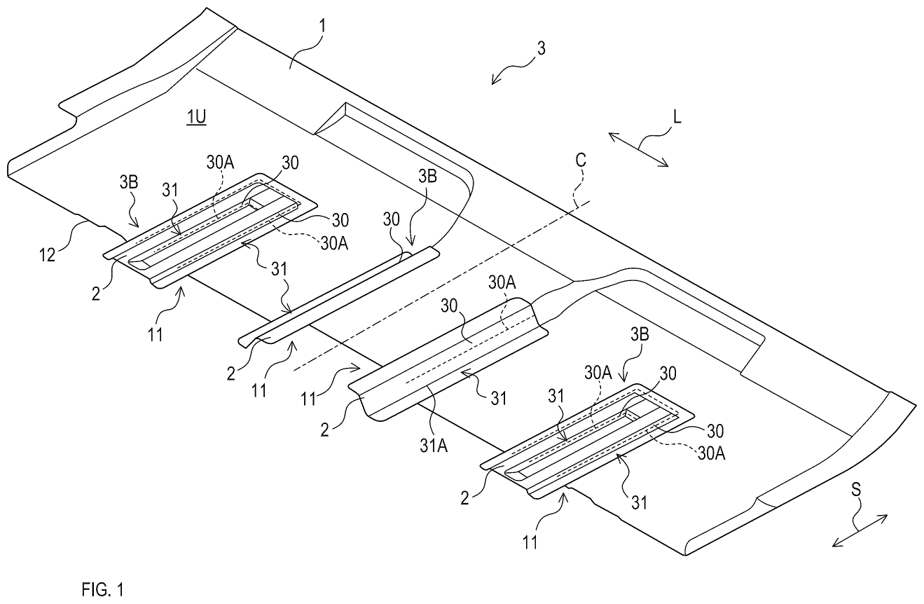

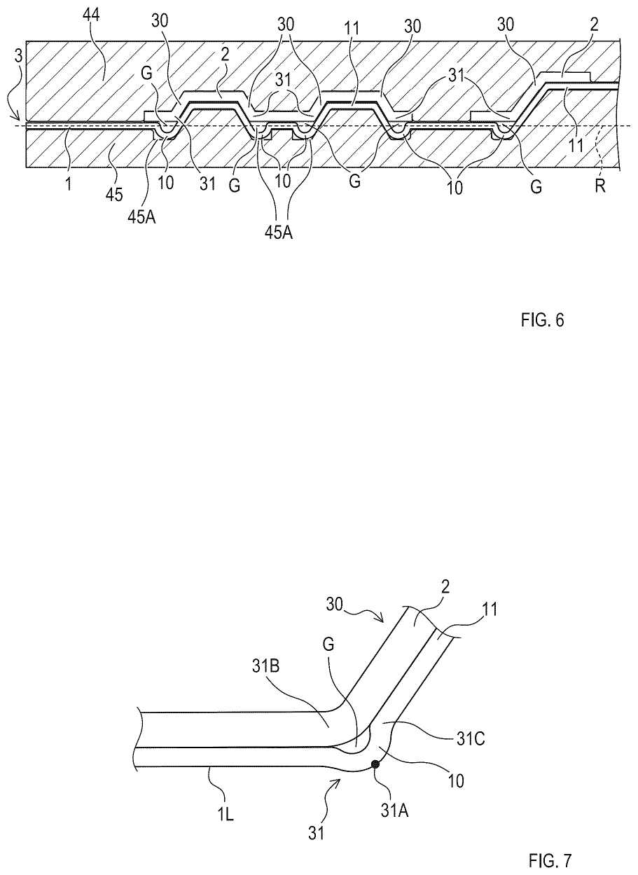

A floor member 3 of the present embodiment is in the form of a plate that forms a floor of a passenger compartment in a body of a vehicle. The floor member 3 has a substantially rectangular shape extending in longitudinal directions L (see, FIGS. 1 and 6). In one example, the floor member 3 has a line symmetrical shape about a center axis C that passes a center of the floor member 3 in the longitudinal directions L. The floor member 3 is mounted on the vehicle so that the longitudinal directions L coincide with vehicle-width directions. Needless to say, the shape of the floor member 3 can be appropriately determined. Moreover, the floor member 3 may be, for example, a part of a floor of a cargo room of the vehicle.

The floor member 3 comprises a body member 1 and two or more reinforcing members 2, and two or more slanting parts 30. Hereinafter, in the floor member 3 mounted on the vehicle, upper and lower surfaces of the body member 1 are referred to as “upper and lower surfaces 1U and 1L”; and upper and lower surfaces of the two or more reinforcing members 2 are referred to as “upper and lower surfaces 2U and 2L”.

### (1) Body Member

In one example, the body member 1 is in the form of a substantially rectangular plate extending in the longitudinal directions L (see, FIG. 1). Needless to say, the shape of the body member 1 is not limited hereto, and can be appropriately determined. Furthermore, in one example, the body member 1 may be made of a steel plate with a tensile strength of 440 MPa or lower. Still further, in one example, the body member 1 may have a thickness of 0.5 mm or more and 1.0 mm or less.

### [(2) Reinforcing Member]

In one example, each reinforcing member 2 is in the form of a substantially rectangular plate. Each reinforcing member 2 is thicker than the body member 1 (see, FIG. 1). In one example, each reinforcing member 2 may have a tensile strength higher than that of the body member 1, and may be made of a steel plate with a tensile strength of 440 MPa or more and 1470 MPa or less. Moreover, in one example, each reinforcing member 2 may have a thickness of 1.0 mm or more and 1.8 mm or less.

Each reinforcing member 2 is joined to the upper surface 1U of the body member 1 for reinforcement. Each reinforcing member 2 covers a part of the body member 1, adjacent to one of its ends (hereinafter, “longitudinal end 12”) extending in the longitudinal directions L, and extends beyond the longitudinal end 12. Needless to say, the location of the reinforcing member 2 can be appropriately determined. For example, the reinforcing member 2 may be arranged so as to extend beyond an end of the body member 1 extending in width directions S orthogonal to the longitudinal directions L. Furthermore, all of or some of the two or more reinforcing members 2 may be arranged so as not to extend beyond the body member 1. Hereinafter, the part of the body member 1 covered with each reinforcing member 2 is referred to as “covered part 11”. In the present embodiment, the body member 1 is provided with two or more covered parts 11 in one example, and each covered part 11 is provided adjacent to the longitudinal end 12 of the body member 1. However, the present disclosure is not limited hereto. The location of each covered part 11 can be appropriately determined.

### [(3) Slanting Part(s)]

At least one slanting part 30 is provided so as to correspond to each reinforcing member 2 (see, FIG. 1). The slanting part 30 includes a portion of its corresponding reinforcing member 2 and a portion of the covered part 11 overlapping the portion of this reinforcing member 2. The slanting part 30 is provided along a specific path 30A. In a cross-section orthogonal to the path 30A, the slanting part 30 extends in a direction intersecting a reference plane R (see, FIG. 6). It should be noted that the reference plane R is an imaginary plane orthogonal to directions in which the reinforcing member 2 and the body member 1 face each other, and expands along the longitudinal directions L and the width directions S. In one example, the slanting part 30 intersects the reference plane R at an obtuse angle; however, the intersecting angle between the slanting part 30 and the reference plane R can be appropriately determined.

In the present embodiment, there are two or more protrusions 3B formed in the floor member 3 in one example. The two or more protrusions 3B protrude towards the upper surfaces 1U and 2U (in other words, towards the two or more reinforcing members 2) with little heights. In one example, the two or more protrusions 3B are adjacent to the longitudinal end 12 and aligned along the longitudinal directions L. It should be noted that the location of the two or more protrusions 3B is not limited hereto, and can be appropriately determined. Furthermore, the floor member 3 may be provided with a single protrusion 3B. The slanting part 30 forms an edge of each protrusion 3B. In other words, each of lower ridgeline parts 31, which are described below, is provided along the edge of a corresponding one of the protrusions 3B.

Specifically, in one example, the floor member 3 includes four reinforcing members 2 and four covered parts 11 that are aligned in a line (hereinafter, “alignment line”) in the longitudinal directions L. Two slanting parts 30 are provided along paths 30A in a square U-shape so as to correspond to each of two reinforcing members 2 located at both ends of the alignment line. Both ends of each path 30A for a corresponding one of these two slanting parts 30 are located at the longitudinal end 12. Each path 30A includes two of first sections extending linearly from the longitudinal end 12 in the width directions S, and a single second section extending linearly in the longitudinal directions L so as to connect respective ends of these first sections opposite to the longitudinal end 12. One path 30A is located outside the other path 30A.

A single slanting part 30 is provided along a path 30A extending linearly in the width directions S so as to correspond to each of two reinforcing members 2 located at a center of the alignment line. The path 30A extends from the longitudinal end 12 and runs across the reinforcing member 2.

Needless to say, the location and the number of the reinforcing members 2, the number of the slanting parts 30 corresponding to each reinforcing member 2, and the location and the shape of the slanting part(s) 30 can be appropriately determined. Furthermore, for example, there may be provided a reinforcing member 2 without the slanting part 30.

### 2. Method of Manufacturing Floor Member

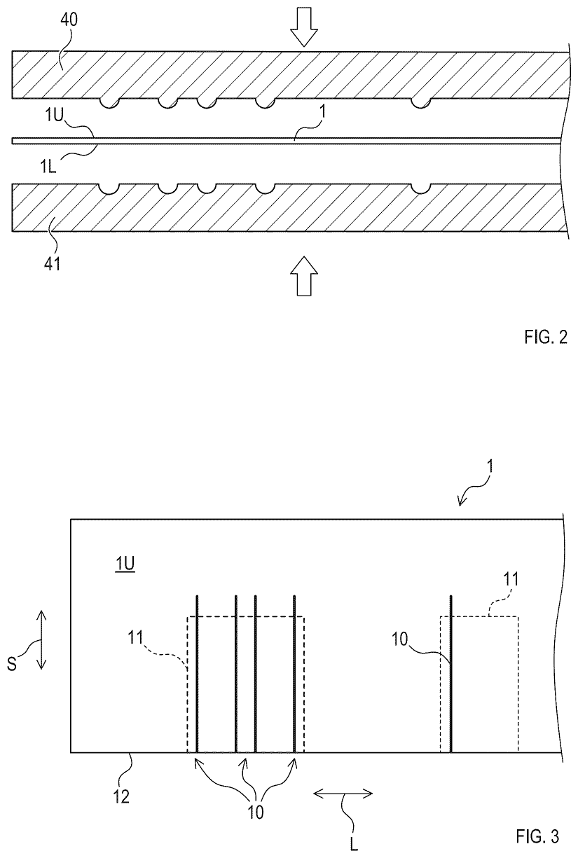

The floor member 3 is manufactured by a patchwork. Specifically, in a process of manufacturing the floor member 3, the two or more slanting parts 30 (in other words, the two or more protrusions 3B) are formed by performing cold press forming on the body member 1 and the two or more reinforcing members 2 that have been joined by spot welding. A method of manufacturing the floor member 3 comprises a bead forming process, a joining process, and a pressing process (see, FIGS. 2 to 6).

### [(1) Bead Forming Process]

In the bead forming process, the cold press forming is performed on the body member 1, which is a blank in the form of a substantially rectangular plate. Consequently, a bead is formed in each bead part 10 of two or more elongated bead parts 10 that are pre-defined in the body member 1. In a cross-section orthogonal to an extending direction of the bead part 10, the bead is bent so as to protrude from the lower surface 1L (see, FIGS. 2 and 3).

Specifically, the body member 1 is placed between the upper die 40 and the lower die 41 that are arranged to face each other (see, FIG. 2). The upper die 40 and the lower die 41 are brought closer to each other and press the body member 1 while interposing the same therebetween, to thereby form the bead from a first end to a second end of each bead part 10. It should be noted that appropriate determinations can be made regarding the location and the orientation to arrange the upper die 40 and the lower die 41, and the method of bringing the upper die 40 and the lower die 41 closer to each other in the cold press forming.

Specifically, in the body member 1, the location of each covered part 11 (in other words, the location to arrange each reinforcing member 2) and the location of each slanting part 30 formed in the subsequent pressing process are pre-determined. As described above, in one example, the location of the covered part 11 is determined so that the covered part 11 is adjacent to the longitudinal end 12. Moreover, the location of the slanting part 30 is determined so that the slanting part 30 overlaps its corresponding covered part 11.

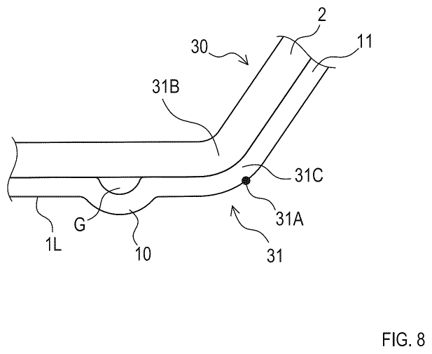

Each bead part 10 is provided so as to correspond to a corresponding one of the slanting parts 30, in other words, a corresponding one of the lower ridgeline parts 31 (a description will be provided later) formed in the slanting parts 30 (see, FIGS. 1 and 6 to 8). The location of each bead part 10 is adjusted so that the bead part 10 is located at or near a corresponding one of ridgeline covered portions 31C included in the lower ridgeline parts 31 when the lower ridgeline part 31 corresponding to this bead part 10 is formed in the subsequent pressing process. Each bead part 10 is located along the path 30A on which the corresponding one slanting part 30 is provided, and more specifically, along a ridgeline 31A of the corresponding one lower ridgeline part 31, and crosses the covered part 11 to which this slanting part 30 corresponds (see, FIG. 3).

In the present embodiment, four bead parts 10 are provided in one example so as to correspond to the two slanting parts 30 of each of the reinforcing members 2 located at the both ends of the alignment line in the longitudinal directions L. These bead parts 10 are arranged along the respective first sections of the paths 30A of the slanting parts 30 extending in the width directions S. In addition to this arrangement, for example, the bead parts 10 may be provided along the respective second sections of the paths 30A extending in the longitudinal directions L. Moreover, a single bead part 10 is provided so as to correspond to the slanting part 30 provided to each of the two reinforcing members 2 that are located at the center of the alignment line.

Each bead part 10 extends linearly in the width directions S from the longitudinal end 12 of the covered part 11 where the slanting part 30 corresponding to this bead part 10 is provided, and reaches to the outside of the covered part 11 in the body member 1.

Needless to say, there may be a covered part 11 without the bead part 10, for example. Moreover, there may be provided a bead part 10 whose one end or both ends are located in the covered part 11 without crossing the covered part 11.

### [(2) Joining Process]

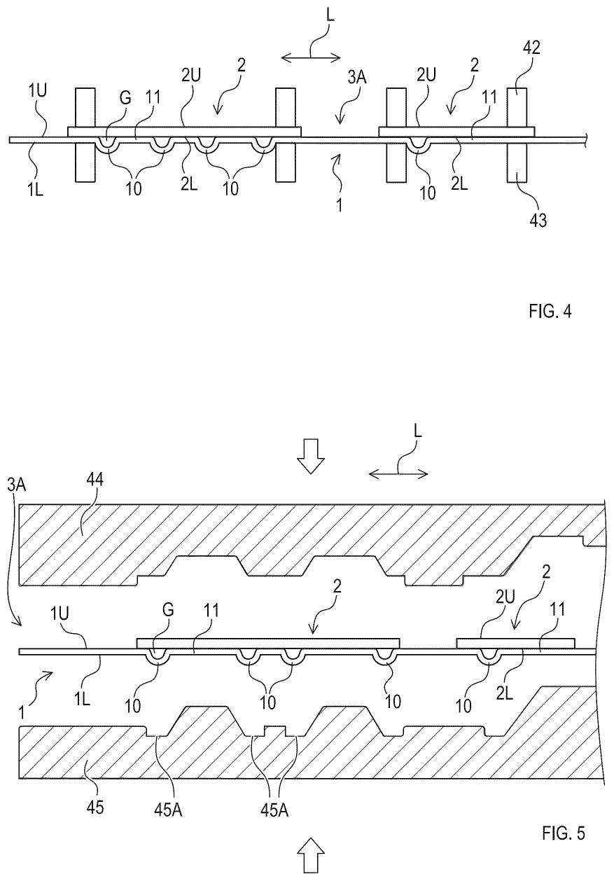

In the joining process, the two or more reinforcing members 2 are arranged on the upper surface 1U of the body member 1 in which two or more beads are formed (see, FIG. 4). At this time, each reinforcing member 2 covers the corresponding one covered part 11 located at a pre-defined position in the body member 1 and extends beyond the longitudinal end 12. Each covered part 11 is provided with at least one bead part 10, and there is a gap G formed between this bead part 10 and the lower surface 2L of its corresponding reinforcing member of the two or more reinforcing members 2.

The body member 1 and each reinforcing member 2 are welded, whereby a joined member 3A is formed. In one example, the joined member 3A may be formed by performing spot welding of the body member 1 and each reinforcing member 2 with an upper electrode 42 contacting the upper surface 2U of the reinforcing member 2 and a lower electrode 43 contacting the lower surface 1L of the body member 1. In one example, a portion of the reinforcing member 2 near its end is welded to the body member 1; however, a weld portion of the reinforcing member 2 is not limited hereto, and can be appropriately determined.

### [(3) Pressing Process]

In the pressing process, cold press forming is performed on the joined member 3A, whereby the two or more slanting parts 30 are formed. Consequently, the joined member 3A is formed into the floor member 3.

Specifically, the joined member 3A is placed between an upper die 44 and a lower die 45 that are arranged so as to face each other (see, FIG. 5). The upper die 44 and the lower die 45 are brought closer to each other and press the joined member 3A while interposing the same therebetween, to thereby form the two or more slanting parts 30 (see, FIG. 6). The upper die 44 presses the joined member 3A from the upper surfaces 1U and 2U (in other words, from the reinforcing member 2). The lower die 45 contacts the lower surface 1L of the body member 1 and presses the joined member 3A from the lower surface 1L. It should be noted that a surface of the lower die 45 to press the lower surface 1L of the body member 1 is provided with two or more recesses 45A configured to arrange therein the beads in the respective bead parts 10 of the body member 1. Furthermore, appropriate determinations can be made regarding the location and the orientation to arrange the upper die 44 and the lower die 45, and the method of bringing the upper die 44 and the lower die 45 closer to each other in the cold press forming.

As described above, each slanting part 30 is formed along a corresponding one of the paths 30A that are pre-defined, and the body member 1 is provided with the bead parts 10 along the respective paths 30A. Thus, each slanting part 30 is formed along a corresponding one of the bead parts 10.

Furthermore, the lower ridgeline part 31 is formed in an edge of each slanting part 30 located on its lower side (see, FIG. 1). The lower ridgeline part 31 extends along the ridgeline 31A. It should be noted that the ridgeline 31A is located at or near the edge of the slanting part 30, and extends along the slanting part 30. In a cross-section orthogonal to the ridgeline 31A, the lower ridgeline part 31 is bent so as to protrude towards the body member 1 (in other words, downwards) (see, FIGS. 6 to 8). In one example, in the cross-section, the ridgeline 31A is located at a substantially center of a portion of the lower surface 1L in the covered part 11 where the lower ridgeline part 31 is located. Furthermore, the lower ridgeline part 31 includes a ridgeline reinforcing portion 31B, which is a portion of the reinforcing member 2; and a ridgeline covered portion 31C, which is a portion of the covered part 11 facing the ridgeline reinforcing portion 31B.

In the floor member 3, each bead part 10 is located at or near the ridgeline covered portion 31C of its corresponding one lower ridgeline part 31. In other words, the ridgeline covered portion 31C may include the entirety of or a portion of the bead part 10. Furthermore, the bead part 10 may be located at a position in the slanting part 30. Alternatively, the bead part 10 may be located at a position in a part of the body member 1 different from the slanting part 30, away from the ridgeline covered portion 31C. Still further, when each slanting part 30 is formed by the press forming, the bead part 10 is stretched out and the bead is squashed. Consequently, the gap G between each bead part 10 and its corresponding one reinforcing member 2 is reduced.

In the present embodiment, the gap G remains between at least one bead part 10 and the reinforcing member 2 in one example. There may be the gap G in a partial area of the bead part 10, or the gap G may be formed in the entire area of the bead part 10. More specifically, in one example, there may be gaps G between all the bead parts 10 and the two or more reinforcing members 2. Needless to say, the present disclosure is not limited hereto. The beads in all the bead parts 10 or some of the bead parts 10 are completely squashed, and there may be substantially no gaps G.

### 3. Effects

(1) In a curved portion formed in the lower ridgeline part 31 of the floor member 3 in the cross-section orthogonal to the ridgeline 31A, the ridgeline covered portion 31C is located outwards of the ridgeline reinforcing portion 31B. Thus, the ridgeline covered portion 31C is longer in perimeter than the ridgeline reinforcing portion 31B. The perimeter means a length of the ridgeline covered portion 31C or the ridgeline reinforcing portion 31B in the cross-section from its first end to second end along its upper surface or lower surface. Thus, when the slanting part 30 is formed in the joined member 3A by the cold press forming, there is a possibility where a shear force is generated in a joined part between each reinforcing member 2 and the body member 1, leading to breakage of the joined part.

In the above-described embodiment, however, the location of each bead part 10 in the body member 1 of the joined member 3A is adjusted so that the bead part 10 is located at or near the ridgeline covered portion 31C in the body member 1 after the cold press forming. Thus, stretching occurring in the body member 1 around the ridgeline covered portion 31C can be absorbed with the bead part 10. Consequently, the joined part between the body member 1 and each reinforcing member 2 can be inhibited from being broken due to the cold press forming and delayed fracture of the joined part can be inhibited.

(2) Furthermore, the reinforcing member 2 is arranged so as to extend beyond the body member 1. Thus, an extended portion of the reinforcing member 2 can reinforce another member to be mounted on the vehicle, adjacent to the floor member 3.

(3) Still further, the bead part 10 is provided so as to cross the covered part 11. Thus, when the cold press forming is performed on the joined member 3A, the bead formed in the bead part 10 can more favorably absorb the stretching occurring in the body member 1 around the ridgeline covered portion 31C. Accordingly, the breakage of the joined part between the body member 1 and the reinforcing member 2 can be more favorably inhibited.

(4) Still further, in the floor member 3, there is the gap G formed between the bead part 10 and the reinforcing member 2. Therefore, stiffness of the floor member 3 around the bead part 10 can be improved.

Still further, by allowing generation of the gap G between the bead part 10 and the reinforcing member 2, accuracy in size and the like of the body member 1 and the reinforcing member 2 can be mitigated. Consequently, the floor member 3 can be easily manufactured.

Still further, when a coating is applied to the floor member 3, a coating material can flow in the gap G between the bead part 10 and the reinforcing member 2. This can favorably prevent rust of the floor member 3.

### 4. Other Embodiments

(1) In the above-described embodiment, the slanting part 30 is provided along the straight path 30A, and as a result, the ridgeline 31A and the bead part 10 are also shaped to extend linearly. However, the present disclosure is not limited hereto. The shape of the slanting part 30 and the path 30A can be appropriately determined, and the slanting part 30 and the path 30A may have a bent shape. In this case, the ridgeline 31A and the bead part 10 also have a shape that is bent in accordance with the shape of the slanting part 30. Needless to say, in this case as well, each bead part 10 is located in the floor member 3, at or near the ridgeline covered portion 31C of its corresponding one lower ridgeline part 31 as in the above-described embodiment.

(2) Two or more functions performed by a single element in the above embodiments may be achieved by two or more elements, and a single function performed by a single element may be achieved by two or more elements. Furthermore, two or more functions performed by two or more elements may be achieved by a single element, and a single function performed by two or more elements may be achieved by a single element. Still further, a part of a configuration in the above embodiments may by omitted. At least a part of the configuration in the above embodiments may be added to or replaced with another configuration in the above embodiments.

### 5. Technical Ideas Disclosed in Present Disclosure

### [Item 1]

A method of manufacturing a floor member included in a floor of a vehicle, the method comprising:
forming beads in respective two or more bead parts in a body member in a form of a plate, the beads being bent so as to protrude from a lower surface of the body member;
arranging two or more reinforcing members so as to cover respective upper surfaces of two or more covered parts in the body member, the two or more reinforcing members being in a form of plates thicker than the body member;
welding the body member and the two or more reinforcing members that are arranged in the respective two or more covered parts, to thereby form a joined member; and
performing cold press forming on the joined member, to thereby form the floor member,
one or more lower ridgeline parts being formed by the cold press forming so as to correspond to each of the two or more reinforcing members,
each lower ridgeline part of the one or more lower ridgeline parts extending along a ridgeline,
the each lower ridgeline part including a portion of a corresponding one reinforcing member and a portion of a corresponding one covered part of the two or more covered parts that is covered with the corresponding one reinforcing member,
the each lower ridgeline part being bent so as to protrude towards the body member in a cross-section orthogonal to the ridgeline,
the each lower ridgeline part corresponding to a corresponding one bead part of the two or more beat parts, and
each bead part of the two or more bead parts being located at or near a corresponding one lower ridgeline part of the one or more lower ridgeline parts.

### [Item 2]

The method according to Item 1, wherein at least one reinforcing member of the two or more reinforcing members is arranged so as to extend beyond the body member.

### [Item 3]

The method according to Item 1 or 2, wherein at least one bead part of the two or more bead parts is provided so as to cross a corresponding one covered part of the two or more covered parts.

### [Item 4]

The method according to any one of Items 1 to 3,
wherein, in the floor member, a gap is formed between at least one bead part of the two or more bead parts in the body member and a reinforcing member of the two or more reinforcing members, and
wherein the reinforcing member is provided with a lower ridgeline part of the one or more lower ridgeline parts corresponding to the at least one bead part.

What is claimed is:

1. A method of manufacturing a floor member included in a floor of a vehicle, the method comprising:
forming beads in respective two or more bead parts in a body member in a form of a plate, the beads being bent so as to protrude from a lower surface of the body member;
arranging two or more reinforcing members so as to cover respective upper surfaces of two or more covered parts in the body member, the two or more reinforcing members being in a form of plates thicker than the body member;
welding the body member and the two or more reinforcing members that are arranged in the respective two or more covered parts, to thereby form a joined member; and
performing cold press forming on the joined member, to thereby form the floor member,
one or more lower ridgeline parts being formed by the cold press forming so as to correspond to each of the two or more reinforcing members,
each lower ridgeline part of the one or more lower ridgeline parts extending along a ridgeline,
the each lower ridgeline part including a portion of a corresponding one reinforcing member and a portion of a corresponding one covered part of the two or more covered parts that is covered with the corresponding one reinforcing member,
the each lower ridgeline part being bent so as to protrude towards the body member in a cross-section orthogonal to the ridgeline,
the each lower ridgeline part corresponding to a corresponding one bead part of the two or more beat parts, and
each bead part of the two or more bead parts being located at or near a corresponding one lower ridgeline part of the one or more lower ridgeline parts.

2. The method according to claim 1, wherein at least one reinforcing member of the two or more reinforcing members is arranged so as to extend beyond the body member.

3. The method according to claim 1, wherein at least one bead part of the two or more bead parts is provided so as to cross a corresponding one covered part of the two or more covered parts.

4. The method according to claim 1,
wherein, in the floor member, a gap is formed between at least one bead part of the two or more bead parts in the body member and a reinforcing member of the two or more reinforcing members, and
wherein the reinforcing member is provided with a lower ridgeline part of the one or more lower ridgeline parts corresponding to the at least one bead part.

5. The method according to claim 1, wherein each covered part of the two or more covered parts is provided adjacent to an end of the body member.

6. The method according to claim 5,
wherein the body member has a substantially rectangular shape extending in a longitudinal direction, and
wherein the each covered part is provided adjacent to the end of the body member extending in the longitudinal direction.

7. The method according to claim 1,
wherein the floor member includes at least one protrusion protruding towards the two or more reinforcing members, and
wherein the one or more lower ridgeline parts corresponding to each of the two or more reinforcing members are provided along an edge of the at least one protrusion.

8. The method according to claim 7,
wherein the at least one protrusion includes two or more protrusions,
wherein the body member has a substantially rectangular shape extending in a longitudinal direction, and
wherein the two or more protrusions are arranged in an aligned manner along the longitudinal direction.

9. The method according to claim 8, wherein the two or more bead parts extend along a width direction orthogonal to the longitudinal direction.

10. The method according to claim 1,
wherein the cold press forming performed on the joined member is carried out by pressing the joined member with a lower die from the lower surface of the body member, and
wherein a surface of the lower die to press the lower surface of the body member is provided with two or more recesses configured to arrange therein the respective two or more bead parts.
